(19) United States
(12) Patent Application Publication
(10) Pub. No.: US 2012/0064232 A1
(43) Pub. Date: Mar. 15, 2012

(54) Method of treatment for imparting conductivity to surface of separator-use base member of solid polymer type fuel cell

(76) Inventors: Keisuke Yamazaki, Nagoya-shi (JP); Wataru Hisada, Nagoya-shi (JP); Hiroshi Kihira, Tokyo (JP); Koki Tanaka, Tokyo (JP)

(21) Appl. No.: 12/807,651

(22) Filed: Sep. 10, 2010

(51) Int. Cl. H01M 2/16

(52) U.S. Cl. 427/115

(57) ABSTRACT

The present invention provides a method of treatment for imparting conductivity to a surface of a separator-use base member resulting in little distortion and superior conductive performance for a separator-use base member of a solid polymer type fuel cell made of any of a sheet of stainless steel, titanium, or titanium alloy, comprising a step of spray coating and drying on the surface of the separator-use base member a suspension prepared by mixing conductive compound particles 3 of an average particle size of 1 to 10 μm with ethanol or water so as to form a conductive compound particle-coated layer 2, a step of blasting the conductive compound particle-coated layer 2 with blast particles 4 having an average particle size of 50 to 200 μm so as to drive the conductive compound particles 3 in the inside direction of the separator-use base member 3 and anchor them there, and a step of cleaning off conductive compound particles 3 not anchored to the surface of the separator-use base member 1 at that step and impurities.

### TECHNICAL FIELD

The present invention relates to a method of treatment for imparting conductivity to the surface of a separator-use base member of a solid polymer type fuel cell.

### BACKGROUND ART

A solid polymer type fuel cell is a fuel cell using a polymer film having ion conductivity as an electrolyte. A solid polymer type fuel cell is structured from a plurality of basic units called “unit cells” stacked together and connected in series to generate a high voltage.

A “unit cell” is comprised of a polymer electrolyte film at the inside, catalyst films made of platinum etc. sandwiching it at its two sides, and separator-use base members at the two sides of the catalyst films with current collectors made of carbon fiber (hereinafter referred to as “carbon paper”) interposed. Between one sheet of carbon paper and separator-use base member, a passage is formed for hydrogen gas. Between the other sheet of carbon paper and separator-use base member, a passage for air (oxygen) is formed. The current generated flows from the carbon paper to separator-use base members where it is then taken out.

Therefore, from the viewpoint of energy efficiency, it is desirable to keep the contact resistance between the carbon paper and separator-use base members low. Note that, the contact resistance between the carbon paper and separator-use base members depends mainly on the physical properties at the contact surfaces of the separator-use base members.

As the materials of the separator-use base members of solid polymer type fuel cells, in the past, carbon-based materials had been frequently used, but due to the problem of brittleness, the thickness could not be reduced and it was difficult to make the fuel cell system compact. For this reason, in recent years, separator-use base members made of more robust carbon-based materials have been developed, but there was the problem that manufacturing costs became higher.

Further, in addition to the above carbon-based materials, there are metal materials made of stainless steel, titanium, titanium alloy, etc. These metal materials solved the problem of brittleness which plagued carbon-based materials and enabled the separator-use base members to be made thinner and the fuel cell systems to be made more compact. However, lower contact resistance with the carbon paper and better corrosion resistance remain as issues.

In general, metals with low contact resistance under the operating environments of fuel cells (for example, copper) tend to be inferior in corrosion resistance. As opposed to this, precious metals have the properties of low contact resistance and better corrosion resistance, but use of gold and other expensive precious metals is problematic in terms of economy.

Therefore, in recent years, various methods have been proposed for reducing the amount of use of expensive precious metals or eliminating their use while reducing the contact resistance between the surfaces of separator-use base members and carbon paper.

As a method of reducing the amount of use of precious metal, the art has been disclosed of forming a thin film of a precious metal on the surface of a corrosion resistant metal forming a separator-use base member, then shot peening it to drive the precious metal into the base metal (for example Japanese Patent Publication (A) No. 2005-174624). However, this method requires that the surface of the stainless steel or titanium forming the separator-use base member be treated to improve the conductive performance by gold plating or other surface treatment for forming an expensive precious metal layer (film), so this was not a sufficient solution to the problem from the viewpoint of economy.

From the viewpoint of economy, employing a separator-use base member using an inexpensive corrosion resistant metal such as stainless steel or titanium or a titanium alloy is optimal, but in this case, due to the passivation film or impurities formed on the surface of the separator-use base member, there are the new problems that the contact resistance between the separator-use base members and the carbon paper becomes greater and the energy efficiency of the fuel cell greatly drops.

As a method for solving the problem of the increase in contact resistance due to the passivation film or impurities formed on the surface of a metal separator-use base member, the art has been disclosed of blasting the surface of the separator-use base member with solid plating particles comprised of core particles having a higher hardness than the separator-use base member and coated with a metal having a high corrosion resistance and a low contact resistance with carbon so as to forcibly drive the metal coated with the solid plating material into the surface layer of the separator-use base member (for example, Japanese Patent Publication (A) No. 2001-250565).

However, with this method, there was the problem that since the same solid plating particles were used for repeated blasting, over time, the metal coating layer on the surface of the solid plating particles became thinner, the amount of metal driven into the surface layer of the separator-use base member dropped, and the quality of the surface treatment of the separator-use base member by this method became uneven.

Further, with the method of mechanically driving in hard conductive compound particles by the blast method etc., there was the problem that separator-use base member could distort and deform and the separator could decline in flatness.

Further, as another method for eliminating the problem of the increase in contact resistance due to the passivation film or impurities formed on the surface of the metal separator-use base member, the art has been disclosed of heat treating the for example stainless steel used for the separator-use base member so as to cause the precipitation of carbide-based metal inclusions having conductive performance from the inside to the surface and utilizing the thus precipitated inclusions as electrical conduits (for example, Japanese Patent Publication (A) No. 2003-193206). However, with the method of using heat treatment to improve conductive performance, there were the problems that a long treatment time became necessary and the treatment process became complicated.

### DISCLOSURE OF INVENTION

The present invention has as its object to provide, as a method for solving the above problems, in particular improving the conductive performance of the surface of a separator-use base member of a solid polymer type fuel cell comprised of stainless steel, titanium, or a titanium alloy, a method of treatment for imparting conductivity to a separator-use base member enabling the production of a separator-use base member at a low cost with stable quality and performance without requiring a complicated process and without the liability of distortion being caused in the separator-use base member in a blasting step.

The present invention was made to solve the above problems.

A first aspect of a method of treatment for imparting conductivity to a separator-use base member of a solid polymer type fuel cell according to the present invention treats the surface of a separator-use base member of a solid polymer type fuel cell made of any of a sheet of stainless steel, titanium, or titanium alloy by (i) a step of spray coating and drying a suspension prepared by mixing conductive compound particles of an average particle size of 1 to 10 μm with ethanol or water so as to form a conductive compound particle-coated layer, (ii) a step of blasting the conductive compound particle-coated layer with blast particles having an average particle size of 50 to 200 μm so as to drive the conductive compound particles coated on the surface of the base member in the inside direction of the separator-use base member to anchor them there, and (iii) a step of cleaning off conductive compound particles not anchored to the separator-use base member at that step and impurities on the surface of the separator base member.

A second aspect of the invention comprises a method of treatment for imparting conductivity to a separator-use base member of a solid polymer type fuel cell of the first aspect of the invention wherein a speed of blast particles used as the means for blasting the conductive compound particle-coated layer is 10 to 30 m/sec.

A third aspect of the invention comprises a method of treatment for imparting conductivity to a separator-use base member of a solid polymer type fuel cell of the first aspect of the invention wherein a blast air pressure used as means for blasting the blast particles at the conductive compound particle-coated layer is 0.01 to 0.1 MPa.

A fourth aspect of the invention comprises a method of treatment for imparting conductivity to a separator-use base member of a solid polymer type fuel cell of the first aspect of the invention wherein the conductive compound particles are powders comprised of at least one type of compound selected from Cr₂B, CrB₂, VB, TaB₂, WB, Cr₃C₂, WC, VC, TaC, Mo₂C, Cr₂N, VN, and TaN.

A fifth aspect of the invention comprises a method of treatment for imparting conductivity to a separator-use base member of a solid polymer type fuel cell of the first aspect of the invention wherein the ratio of mass, with respect to a total mass of conductive compound particles of the conductive compound particle-coated layer, of the conductive compound particles anchored by being driven in the inside direction of the separator-use base member after blasting the conductive compound particle-coated layer with the blast particles is 30% or more.

The method of treatment for imparting conductivity to a separator-use base member of a solid polymer type fuel cell according to the present invention treats the surface of a separator-use base member of a solid polymer type fuel cell made of any of stainless steel, titanium, or a titanium alloy by spraying coating and drying a suspension prepared by mixing conductive compound particles having an average particle size of 1 to 10 μm with ethanol or water in advance so as to form a conductive compound particle-coated layer, blasting the conductive compound particle-coated layer with blast particles having an average particle size of 50 to 200 μm so as to drive in and anchor the conductive compound particles forming the conductive compound particle-coated layer in the inside direction of the base member, and thereby forms a conductive film on the surface of the separator-use base member.

The reason for setting the maximum size of the conductive compound particles to 10 μm is to prevent the spray nozzle from being clogged when mixing the particles with ethanol or water to prepare a suspension for spraying by a spray gun.

The reason for setting the average particle size of the blast particles to 50 to 200 μm is to suppress to a minimum the occurrence of warping (distortion) of the separator base member at the later explained blast air pressure (0.01 to 0.1 MPa) and to make the particle size of the blast particles one which enables the necessary amount of conductive compound particles enabling a superior conductive performance to be imparted to be driven into and anchored at the surface of the separator-use base member.

The amount of the conductive compound of the conductive compound particle-coated layer formed by spray coating the separator surface can be controlled by adjusting the mixing ratio of the conductive compound particles and ethanol or water when preparing the suspension or the amount of spray coating of the suspension. Therefore, according to the present invention, it is possible to easily stably control the amount of conductive compound required for making the contact resistance with the carbon paper a target value.

The blast treatment of the present invention plays the role of a hammer for driving the conductive compound particles of the conductive compound particle-coated layer coated in advance on the surface of the separator-use base member into the separator-use base member, so the impact energy, which is determined by the particle size, grade (or mass), of hardness of the blast particles and their impact speed (or blast pressure), need only be one having an impact energy of a level enabling the hammer effect to be exhibited. The impact speed of the blast particles can be a low speed (or the blast pressure should be a low pressure). As a result, it is possible to keep to a minimum the occurrence of warping (distortion) of the separator base member due to the blast treatment, eliminate the drop in conductive performance, reducing the wear and tear on the blast apparatus, and reduce the expenses for repair or maintenance of the blast apparatus.

The speed of impact of blast particles on workpieces used in conventional blast treatment is 50 to 120 m/sec or so, but the speed of impact of blast particles on a worked location of the present invention, as shown in the second aspect of the invention, is a low speed region of 10 to 30 m/sec. It is possible to obtain a hammer effect driving the conductive compound particles into the surface of the separator-use base member and possible to solve the problem of distortion at the separator caused by the blast treatment.

Furthermore, the blast air pressure employed in conventional blast treatment is generally 0.1 MP or more, but the blast air pressure employed in the present invention, as shown in the third aspect of the invention, is a low pressure region of 0.01 to 0.1 MP. It is possible to obtain a hammer effect driving the conductive compound particles into the surface of the separator-use base member and possible to solve the problem of distortion at the separator caused by the blast treatment.

The minimum value 0.01 MPa of the blast air pressure in the present invention is a pressure not causing pulsation in the blast flow, that is, not causing unevenness of blast treatment. The maximum value of 0.1 MPa is a pressure of a range enabling conductive compound particles to be driven into and anchored at the surface of the separator-use base member for forming a film having a superior conductive performance at the surface of the separator-use base member, keeping to a minimum the occurrence of warping (distortion) of the separator-use base member, and not influencing the conductive performance.

Furthermore, as conductive compound particles able to form films superior in the conductive performance, as shown in the fourth aspect of the invention, powders comprised of at least one type of compound selected from Cr₂B, CrB₂, VB, TaB₂, WB, Cr₃C₂, WC, VC, TaC, Mo₂C, Cr₂N, VN, and TaN may be mentioned.

In the present invention, it is possible to use the above various types of powders. The prices of the materials for forming these various powders are low, so the manufacturing costs can be reduced.

To produce a separator-use base member superior in conductive performance, furthermore, as shown in the fifth aspect of the invention, if making the ratio of mass, with respect to a total mass of conductive compound particles contained in the conductive compound particle-coated layer formed by spray coating the surface of the separator-use base member with a suspension prepared in advance, of the conductive compound particles anchored by being driven in the inside direction of the separator-use base member after blasting the coated layer with the blast particles a ratio of 30% or more, it is possible to produce a separator-use base member in which a good conductive performance can be exhibited.

According to the present invention, it is possible to obtain a separator-use base member superior in flatness without causing distortion due to the blast treatment. By using the separator-use base member of the present invention, it is possible to assemble around 800 to 1000 flat fuel cell stacks in each of which a plurality of separator-use base members are superposed and possible in the end to construct a fuel cell superior in conductive performance.

### BRIEF DESCRIPTION OF THE DRAWINGS

FIG. 1 is an explanatory view showing the steps of a method of treatment for imparting conductivity to a separator-use base member of the present invention.

FIG. 2 is an explanatory view for evaluating the warping rate of a separator-use base member of a solid polymer type fuel cell.

### BEST MODE FOR CARRYING OUT THE INVENTION

Below, a production process of a preferred embodiment of the present invention and the selection of materials for producing a separator-use base member having a superior conductive performance will be explained based on the drawings.

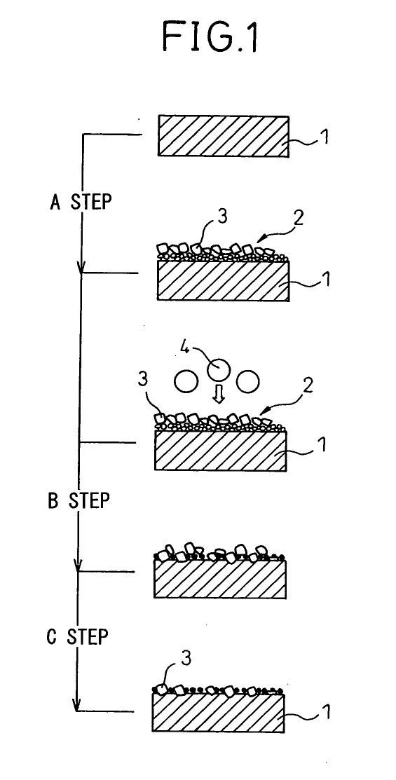

FIG. 1 is a view for explaining the steps of a method of treatment for imparting conductivity to a separator-use base member of the present invention. In FIG. 1, 1 shows a separator-use base member, 2 shows a conductive compound particle-coated layer formed on the surface of the separator-use base member, 3 shows conductive compound particles, and 4 shows blast particles. Further, a step A shows a step of forming a conductive compound particle-coated layer, a step B shows a step of anchoring the conductive compound particle, and a step C shows a step of cleaning off a coated layer.

(Step A of Formation of Conductive Compound Particle-Coated Layer)

The selection of the separator-use base member 1 and the conductive compound particles 3 and solution for mixing and preparing a suspension for forming a conductive compound particle-coated layer 2 on the surface of the separator-use base member 1 prepared at this step will be explained.

The separator-use base member 1 requires weather resistance and corrosion resistance. Specifically, stainless steel, titanium, a titanium alloy, etc. may be selected.

The conductive compound particles 3 may be selected from metal borides, metal carbides, and metal nitrides which have conductive performance of course, have acid resistance and corrosion resistance, are higher in hardness than the stainless steel, titanium, titanium alloy, etc. employed at the separator-use base member 1, and have an average particle size of 1 to 10 μm.

Specifically, a metal compound obtained by mixing one or more types of Cr₃C₂, Cr₂N, Cr₂B, CrB₂, VB, VC, VN, W₂B₅, W₂C, WB, WC, TaB₂, TaC, TaN, LaB₆, MoB₂, Mo₂C, MoB, MoC₂, NbC, and NbN may be selected.

The solution is required a) to be nontoxic, b) to have a high volatility for shortening the drying time after coating, c) to be good in wettability for the separator-use base member 1 since uniformity is required for coating action, etc. Specifically, ethanol may be selected. Note that, as another solution, water may be used, but water is poor in wettability with respect to metal, so a thickening agent is preferably added.

Below, the process of mixing and preparing a suspension will be explained.

A tank of a pressurized type coating tank apparatus provided with a pressurizing port to which dried air is fed through a not shown regulator, a feed port connected to a spray gun for spray coating the mixed and prepared suspension from its front end, and a stirring unit for mixing and preparing the suspension in the tank is charged with the conductive compound particles 3 and solution by a mixing ratio of a weight ratio of 1:16 to 1:5. The range set as the mixing ratio is determined in consideration of the mixability of the selected conductive compound particles 3 and solution and the range in which the efficiency of spraying the mixed and prepared suspension is suitable. It is determined by the difference of specific gravities of the conductive compound particles 3 selected.

Next, the stirring unit is driven to stir the conductive compound particles 3 and solution charged into the tank of the pressurized type coating tank apparatus to mix and prepare the suspension. The pressurizing port is used to feed dry air to pressurize the inside of the tank to 0.1 to 0.2 MPa.

The mixed and prepared suspension is spray coated on the surface of the separator-use base member 1 by the spray gun connected to the feed port of the tank so as to form a conductive compound particle-coated layer 2. The conductive compound particle-coated layer 2 is then dried. The nozzle diameter of the spray gun is about 1.0 mm, while the spray pressure is preferably 0.01 to 0.1 MPa.

The drying method may be natural drying, but if heating to 60 to 100° C., the drying time can be shortened and the productivity rises. The conductive compound particles 3 of the conductive compound particle-coated layer 2 in the state dried at this stage, as shown in FIG. 1, are uniformly coated on the surface of the separator-use base member 1, but the anchoring strength between the particles and with the separator base member is weak. The strength is an extent that if wiped, the particles can be easily removed.
(Step B of Anchoring Conductive Compound Particles)

The conductive compound particle-coated layer 2 formed after spray coating the surface of the separator-use base member 1 and drying it is blasted from a direction perpendicular to the surface of the separator-use base member 1 by blast particles having an average particle size of 50 to 200 μm at a particle speed of 10 to 30 m/sec or, in the case of the air blasting method, is blasted to obtain that particle speed by an air blast pressure of 0.01 to 0.1 MPa, at a rate of 10 to 100 g/cm². Here, in the case where the blast method is a mechanical impeller system not using air, the rotational speed of the impeller should be controlled so that the particle speed of the blast particles becomes the above 10 to 30 m/sec.

The particle speed of 10 to 30 m/sec imparted to the blast particles 4, or the blast pressure of 0.01 to 0.1 MPa, is an extremely low speed giving an impact energy giving only a hammer effect on the conductive compound particles 3 of the conductive compound particle-coated layer 2. The conductive compound particles 3, due to the hammer effect, pass through the passivation film of the conductive compound particle-coated layer 2 and are driven in at the inside direction of the separator-use base member 1.

Further, since the speed of blasting the blast particles 4 is an extremely low speed, even with a thin separator-use base member 1 of a thickness of 0.15 mm or less, the distortion can be kept to a minimum and the wear of the blast apparatus can be reduced.

Further, in the above way, the blast particles are blasted at a low speed, so the damage to the particles is extremely small and the material of the blast particles 4 does not have to be particularly limited, but ultrahard shot, steel shot, and high specific gravity ceramic particles are more preferable. The reason is that the action and object of the blast particles 4 of the present invention are to obtain a hammer effect. If employing high specific gravity particles such as the above ultrahard shot, steel shot, and high specific gravity ceramic particles, it is possible to make the particle speed a low speed and possible to reduce the distortion of the separator-use base member 1. As other actions and effects, mention may be made of the fact that after blasting the blast particles 4, the conductive compound particles 3 detached without being driven into the surface of the separator-use base member 1 can be removed by these blast particles.

(Step C of Cleaning Off Coated Layer)

The separator-use base member 1 after completion of the conductive compound particle-coated layer formation step and the conductive compound particle anchoring step is then treated by a not shown ultrasonic cleaner so as to clean off the conductive compound particles 3 which were not driven in and anchored at the conductive compound particle anchoring step and the impurities.

By going through the above steps, even with a separator-use base member 1 made thin for the purpose of easier shapeability, compactness, and lighter weight, no special apparatus is required. It is possible to easily anchor conductive compound particles 3 at the surface of the separator-use base member 1 without causing distortion.

### EXAMPLES

Below, the test conditions and results of examples and comparative examples run for confirmation purposes will be explained.

### Example 1

A separator-use base member 1 of outer dimensions of 150 mm×150 mm×0.15 mm (thickness) made of titanium was prepared. As conductive compound particles 3, 40 g of vanadium carbide (VC) of an average particle size of 2 μm and 600 g of an ethanol solution were charged into a tank of a not shown pressurized type coating tank apparatus having an inside diameter of 97 mm and an inside capacity of 1 liter. A stirring unit was driven to mix these and prepare a suspension. Note that the area of the surface of the titanium separator-use base member 1 to be imparted conductivity, that is, the area of one side of the separator-use base member 1 spray coated with the suspension to form a conductive compound particle-coated layer and blasted by the blast particles to driven in the conductive compound particles to anchor them, was made 100×100 mm=10,000 mm² (100 cm²). Note that, the weights of the conductive compound particles 3 and ethanol solution show the weights charged for mixing and preparing the suspension for spraying coating one side of the separator-use base member 1.

Next, the pressurizing port was fed, through a regulator, with 0.1 MPa dried air to pressurize the inside of the tank. Due to this pressurization, the mixed and prepared suspension in the tank was fed to a spray gun through a PTFE tube of an inside diameter of 4 mm connected to the feed port. The suspension fed to the spray gun was spray coated by a pressure of 0.1 MPa on the surface of the separator-use base member 1 to form the conductive compound particle-coated layer 2.

The amount of the suspension spray coated per unit area for forming the conductive compound particle-coated layer 2 was made about 0.2 mg/cm², while the area spray coated was made 100×100 mm (100 cm²/side). This ended step A of forming the conductive compound particle-coated layer.

After the end of the spray coating, the separator-use base member 1 was loaded into an incubator held at 80° C. where the ethanol solution was evaporated to dry the coating.

The finished dried separator-use base member 1 was fastened to a table arranged in a not shown gravity type air blasting cabinet. The air blast nozzle was set so that its front end was positioned a distance of 200 mm away from the surface of the conductive compound particle-coated layer 2 of the separator-use base member 1 and oriented in the perpendicular direction. Next, ultrahard shot of an average particle size of 100 μm was blasted from the air blast nozzle by a blast air pressure of 0.015 MPa and a blast density of 23 g/cm² to blast the shot at the surface of the conductive compound particle-coated layer 2 of the separator-use base member 1 and thereby anchor the conductive compound particles. This ended step B.

By the above, the step A of forming a conductive compound particle-coated layer on one side of the separator-use base member 1 and the step B of anchoring the conductive compound particles were completed. In the same way, the above steps were performed for the other side as well. The separator-use base member 1 was then loaded into an ultrasonic cleaner to clean off the dust generated and deposited at the time of blasting and the excess conductor compound particles 3 of vanadium carbide (VC) etc. not anchored to the surface of the separator-use base member 1, then the member was loaded into an incubator and dried. This ended step C of cleaning off the coated layer.

### Example 2

100 g of TaN of an average particle size of 4 μm and 600 g of an ethanol solution were charged into the tank of a pressurized type coating tank apparatus similar to Example 1 to mix and prepare a suspension. Next, the suspension in the tank was pressurized and fired from a spray gun so as to spray coat the surface of a separator-use base member 1 having the same outer dimension as Example 1 of 150 mm×150 mm×0.15 mm (thickness) and made of titanium by an amount of coating per unit area of 1.0 mg/cm². The rest of the test conditions were the same as in Example 1.

### Example 3

40 g of VC of an average particle size of 2 μm and 600 g of an ethanol solution were charged into the tank of a pressurized type coating tank apparatus similar to Example 1 to mix and prepare a suspension. Next, the suspension in the tank was pressurized and fired from a spray gun so as to spray coat the surface of a separator-use base member 1 having the same outer dimension as Example 1 of 150 mm×150 mm×0.15 mm (thickness) and made of titanium by an amount of coating per unit area of 0.2 mg/cm² and was dried. After this, using, as the blast particles used in step B of anchoring the conductive compound particles, TiN of an average particle size of 100 μm and a pressure of 0.018 MPa, the conductive compound particle-coated layer 2 formed on the surface of the separator-use base member 1 was blasted. The rest of the test conditions were the same as in Example 1.

### Example 4

100 g of TaN of an average particle size of 4 μm and 600 g of an ethanol solution were charged into the tank of a pressurized type coating tank apparatus similar to Example 1 to mix and prepare a suspension. Next, the suspension in the tank was pressurized and fired from a spray gun so as to spray coat the surface of a separator-use base member 1 having the same outer dimension as Example 1 of 150 mm×150 mm×0.15 mm (thickness) and made of titanium by an amount of coating per unit area of 1.0 mg/cm² and was dried. After this, using, as the blast particles used in step B of anchoring the conductive compound particles, TiN of an average particle size of 100 μm and a pressure of 0.018 MPa, the conductive compound particle-coated layer 2 formed on the surface of the separator-use base member 1 was blasted. The rest of the test conditions were the same as in Example 1.

### Example 5

40 g of VC of an average particle size of 2 μm and 600 g of an ethanol solution were charged into the tank of a pressurized type coating tank apparatus similar to Example 1 to mix and prepare a suspension. Next, the suspension in the tank was pressurized and fired from a spray gun so as to spray coat the surface of a separator-use base member 1 having the same outer dimension as Example 1 of 150 mm×150 mm×0.15 mm (thickness) and made of titanium by an amount of coating per unit area of 0.2 mg/cm² and was dried. After this, using, as the blast particles used in step B of anchoring the conductive compound particles, glass beads of an average particle size of 180 μm and a pressure of 0.080 MPa, the conductive compound particle-coated layer 2 formed on the surface of the separator-use base member 1 was blasted. The rest of the test conditions were the same as in Example 1.

### Example 6

100 g of TaN of an average particle size of 4 μm and 600 g of an ethanol solution were charged into the tank of a pressurized type coating tank apparatus similar to Example 1 to mix and prepare a suspension. Next, the suspension in the tank was pressurized and fired from a spray gun so as to spray coat the surface of a separator-use base member 1 having the same outer dimension as Example 1 of 150 mm×150 mm×0.15 mm (thickness) and made of titanium by an amount of coating per unit area of 1.0 mg/cm² and was dried. After this, using, as the blast particles used in step B of anchoring the conductive compound particles, glass beads of an average particle size of 180 μm and a pressure of 0.080 MPa, the conductive compound particle-coated layer 2 formed on the surface of the separator-use base member 1 was blasted. The rest of the test conditions were the same as in Example 1.

### Example 7

40 g of VC of an average particle size of 4 μm and 600 g of an ethanol solution were charged into the tank of a pressurized type coating tank apparatus similar to Example 1 to mix and prepare a suspension. Next, the suspension in the tank was pressurized and fired from a spray gun so as to spray coat the surface of a separator-use base member 1 having the same outer dimension as Example 1 of 150 mm×150 mm×0.15 mm (thickness) and made of stainless steel (SUS316L) by an amount of coating per unit area of 0.2 mg/cm² and was dried. After this, using, as the blast particles used in step B of anchoring the conductive compound particles, ultrahard shot of an average particle size of 100 μm and a pressure of 0.015 MPa, the conductive compound particle-coated layer 2 formed on the surface of the separator-use base member 1 was blasted. The rest of the test conditions were the same as in Example 1.

### Example 8

100 g of TaN of an average particle size of 4 μm and 600 g of an ethanol solution were charged into the tank of a pressurized type coating tank apparatus similar to Example 1 to mix and prepare a suspension. Next, the suspension in the tank was pressurized and fired from a spray gun so as to spray coat the surface of a separator-use base member 1 having the same outer dimension as Example 1 of 150 mm×150 mm×0.15 mm (thickness) and made of stainless steel (SUS316L) by an amount of coating per unit area of 1.0 mg/cm² and was dried. After this, using, as the blast particles used in step B of anchoring the conductive compound particles, TiN of an average particle size of 100 μm and a pressure of 0.018 MPa, the conductive compound particle-coated layer 2 formed on the surface of the separator-use base member 1 was blasted. The rest of the test conditions were the same as in Example 1.

### Example 9

20 g of Cr₂B of an average particle size of 6 μm, 20 g of CrB₂ of an average particle size of 3 μm, and 600 g of an ethanol solution were charged into the tank of a pressurized type coating tank apparatus similar to Example 1 to mix and prepare a suspension. Next, the suspension in the tank was pressurized and fired from a spray gun so as to spray coat the surface of a separator-use base member 1 having the same outer dimension as Example 1 of 150 mm×150 mm×0.15 mm (thickness) and made of stainless steel (SUS316L) by an amount of coating per unit area of 0.2 mg/cm² and was dried. After this, using, as the blast particles used in step B of anchoring the conductive compound particles, ultrahard shot of an average particle size of 100 μm and a pressure of 0.015 MPa, the conductive compound particle-coated layer 2 formed on the surface of the separator-use base member 1 was blasted. The rest of the test conditions were the same as in Example 1.

### Example 10

40 g of VB of an average particle size of 3 μm and 600 g of an ethanol solution were charged into the tank of a pressurized type coating tank apparatus similar to Example 1 to mix and prepare a suspension. Next, the suspension in the tank was pressurized and fired from a spray gun so as to spray coat the surface of a separator-use base member 1 having the same outer dimension as Example 1 of 150 mm×150 mm×0.15 mm (thickness) and made of stainless steel (SUS316L) by an amount of coating per unit area of 0.2 mg/cm² and was dried. After this, using, as the blast particles used in step B of anchoring the conductive compound particles, ultrahard shot of an average particle size of 100 μm and a pressure of 0.015 MPa, the conductive compound particle-coated layer 2 formed on the surface of the separator-use base member 1 was blasted. The rest of the test conditions were the same as in Example 1.

### Example 11

100 g of TaB₂ of an average particle size of 5 μm and 600 g of an ethanol solution were charged into the tank of a pressurized type coating tank apparatus similar to Example 1 to mix and prepare a suspension. Next, the suspension in the tank was pressurized and fired from a spray gun so as to spray coat the surface of a separator-use base member 1 having the same outer dimension as Example 1 of 150 mm×150 mm×0.15 mm (thickness) and made of stainless steel (SUS316L) by an amount of coating per unit area of 1.0 mg/cm² and was dried. After this, using, as the blast particles used in step B of anchoring the conductive compound particles, TiN of an average particle size of 100 μm and a pressure of 0.018 MPa, the conductive compound particle-coated layer 2 formed on the surface of the separator-use base member 1 was blasted. The rest of the test conditions were the same as in Example 1.

### Example 12

40 g of Cr₃C₂ of an average particle size of 7 μm and 600 g of an ethanol solution were charged into the tank of a pressurized type coating tank apparatus similar to Example 1 to mix and prepare a suspension. Next, the suspension in the tank was pressurized and fired from a spray gun so as to spray coat the surface of a separator-use base member 1 having the same outer dimension as Example 1 of 150 mm×150 mm×0.15 mm (thickness) and made of titanium by an amount of coating per unit area of 0.2 mg/cm² and was dried. After this, using, as the blast particles used in step B of anchoring the conductive compound particles, TiN of an average particle size of 100 μm and a pressure of 0.018 MPa, the conductive compound particle-coated layer 2 formed on the surface of the separator-use base member 1 was blasted. The rest of the test conditions were the same as in Example 1.

### Example 13

50 g of WC of an average particle size of 5 μm, 50 g of WB of an average particle size of 4 μm, and 600 g of an ethanol solution were charged into the tank of a pressurized type coating tank apparatus similar to Example 1 to mix and prepare a suspension. Next, the suspension in the tank was pressurized and fired from a spray gun so as to spray coat the surface of a separator-use base member 1 having the same outer dimension as Example 1 of 150 mm×150 mm×0.15 mm (thickness) and made of titanium by an amount of coating per unit area of 1.0 mg/cm² and was dried. After this, using, as the blast particles used in step B of anchoring the conductive compound particles, glass beads of an average particle size of 180 μm and a pressure of 0.080 MPa, the conductive compound particle-coated layer 2 formed on the surface of the separator-use base member 1 was blasted. The rest of the test conditions were the same as in Example 1.

### Example 14

100 g of TaC of an average particle size of 3 μm and 600 g of an ethanol solution were charged into the tank of a pressurized type coating tank apparatus similar to Example 1 to mix and prepare a suspension. Next, the suspension in the tank was pressurized and fired from a spray gun so as to spray coat the surface of a separator-use base member 1 having the same outer dimension as Example 1 of 150 mm×150 mm×0.15 mm (thickness) and made of titanium by an amount of coating per unit area of 1.0 mg/cm² and was dried. After this, using, as the blast particles used in step B of anchoring the conductive compound particles, glass beads of an average particle size of 180 μm and a pressure of 0.080 MPa, the conductive compound particle-coated layer 2 formed on the surface of the separator-use base member 1 was blasted. The rest of the test conditions were the same as in Example 1.

### Example 15

60 g of Mo₂C of an average particle size of 4 μm and 600 g of an ethanol solution were charged into the tank of a pressurized type coating tank apparatus similar to Example 1 to mix and prepare a suspension. Next, the suspension in the tank was pressurized and fired from a spray gun so as to spray coat the surface of a separator-use base member 1 having the same outer dimension as Example 1 of 150 mm×150 mm×0.15 mm (thickness) and made of titanium by an amount of coating per unit area of 0.6 mg/cm² and was dried. After this, using, as the blast particles used in step B of anchoring the conductive compound particles, ultrahard shot of an average particle size of 100 μm and a pressure of 0.015 MPa, the conductive compound particle-coated layer 2 formed on the surface of the separator-use base member 1 was blasted. The rest of the test conditions were the same as in Example 1.

### Example 16

50 g of Cr₂N of an average particle size of 8 μm and 600 g of an ethanol solution were charged into the tank of a pressurized type coating tank apparatus similar to Example 1 to mix and prepare a suspension. Next, the suspension in the tank was pressurized and fired from a spray gun so as to spray coat the surface of a separator-use base member 1 having the same outer dimension as Example 1 of 150 mm×150 mm×0.15 mm (thickness) and made of titanium by an amount of coating per unit area of 0.2 mg/cm² and was dried. After this, using, as the blast particles used in step B of anchoring the conductive compound particles, TiN of an average particle size of 100 μm and a pressure of 0.018 MPa, the conductive compound particle-coated layer 2 formed on the surface of the separator-use base member 1 was blasted. The rest of the test conditions were the same as in Example 1.

### Example 17

40 g of VN of an average particle size of 6 μm and 600 g of an ethanol solution were charged into the tank of a pressurized type coating tank apparatus similar to Example 1 to mix and prepare a suspension. Next, the suspension in the tank was pressurized and fired from a spray gun so as to spray coat the surface of a separator-use base member 1 having the same outer dimension as Example 1 of 150 mm×150 mm×0.15 mm (thickness) and made of stainless steel (SUS316L) by an amount of coating per unit area of 0.2 mg/cm² and was dried. After this, using, as the blast particles used in step B of anchoring the conductive compound particles, TiN of an average particle size of 100 μm and a pressure of 0.015 MPa, the conductive compound particle-coated layer 2 formed on the surface of the separator-use base member 1 was blasted. The rest of the test conditions were the same as in Example 1.

### Comparative Example 1

The steps of preparing the suspension and coating the suspension performed in Examples 1 to 17 were omitted. VC similar to that used for the conductive compound particles 3 in Example 1 was blasted under the same blast conditions as step B for anchoring the conductive compound particles of Example 1, that is, a blast air pressure of 0.015 MPa and a blast density of 23 g/cm², directly on the surface of the separator-use base member 1 to anchor conductive compound particles 3 of VC at the surface of the separator-use base member 1. After that, the separator-use base member 1 was treated by an ultrasonic cleaner to clean off the dust generated at the time of blasting and the excess conductive compound particles 3 which failed to be anchored.

### Comparative Example 2

Except for changing the blast air pressure to 0.4 MPa, the test conditions were made the same as in Comparative Example 1 to directly blast conductive compound particles 3 (VC) on the surface of the separator-use base member 1. After this, the separator-use base member 1 was cleaned by an ultrasonic cleaner.

### Comparative Example 3

Except for changing the blast air pressure to 0.4 MPa in the same way as Comparative Example 2 and changing the conductive compound particles 3 to TaN, the test conditions were made the same as in Comparative Example 1 to directly blast conductive compound particles 3 (TaN) on the surface of the separator-use base member 1. After this, the separator-use base member 1 was cleaned by an ultrasonic cleaner.

### Comparative Example 4

Except for changing the material of the separator base member to stainless steel (SUS316L), the test conditions were made the same as in Comparative Example 3 to directly blast conductive compound particles 3 (TaN) on the surface of the separator-use base member 1 (SUS316L). After this, the separator-use base member 1 was cleaned by an ultrasonic cleaner.

The amount of conductive compound particles anchored per unit area (mg/cm²), the average value of the surface roughnesses of the front and back surfaces of the separator-use base member 1 after treatment (arithmetic surface roughness Ra and 10-point average roughness Rz), the evaluation of the contact resistance of the separator-use base member 1 and the carbon paper, and the evaluation of the warping of the separator-use base member 1 on the diagonal line for each of the above Examples 1 to 17 and Comparative Examples 1 to 4 are shown in Table 1.

TABLE 1

| | | | | | Surface roughness | | | |
|---|---|---|---|---|---|---|---|---|
| | | | | Amount of | (Average of front and back | | | |
| | | | | conductive | after treatment) | | Measurement and evaluation | |
| | Test conditions | | | compound | Arithmetic | 10-point | results | |
| | Conductive | | Blass air | particles | surface | average | Evaluation of | Evaluation of |
| | compound | Blast | pressure | anchored | roughness Ra | roughness Rz | contact | warping on |
| | particles | particles | (MPa) | (mg/cm²) | (μm) | (μm) | resistance | diagonal line |
| Ex. 1 | VC | Ultrahard shot | 0.015 | 0.028 | 0.3354 | 1.741 | Good | Good |
| Ex. 2 | TaN | Ultrahard shot | 0.015 | 0.057 | 0.3462 | 1.797 | Good | Good |
| Ex. 3 | VC | TiN | 0.018 | 0.031 | 0.3651 | 2.929 | Good | Good |
| Ex. 4 | TaN | TiN | 0.018 | 0.061 | 0.3763 | 2.916 | Good | Good |
| Ex. 5 | VC | Glass beads | 0.080 | 0.023 | 0.5118 | 3.662 | Good | Fair |
| Ex. 6 | TaN | Glass beads | 0.080 | 0.043 | 0.5388 | 3.855 | Good | Fair |
| Ex. 7 | VC | Ultrahard shot | 0.015 | 0.031 | 0.3518 | 1.826 | Good | Good |
| Ex. 8 | TaN | TiN | 0.018 | 0.072 | 0.3961 | 3.069 | Good | Good |
| Ex. 9 | Cr₂B, CrB₂ | Ultrahard shot | 0.015 | 0.030 | 0.4151 | 2.155 | Good | Good |
| Ex. 10 | VB | Ultrahard shot | 0.015 | 0.055 | 0.4518 | 2.345 | Good | Good |
| Ex. 11 | TaB₂ | TiN | 0.018 | 0.030 | 0.4824 | 3.738 | Good | Good |
| Ex. 12 | Cr₃C₂ | TiN | 0.018 | 0.065 | 0.4765 | 3.692 | Good | Good |
| Ex. 13 | WC, WB | Glass beads | 0.080 | 0.026 | 0.5088 | 3.640 | Good | Fair |
| Ex. 14 | TaC | Glass beads | 0.080 | 0.041 | 0.5206 | 3.725 | Good | Fair |
| Ex. 15 | Mo₂C | Ultrahard shot | 0.015 | 0.033 | 0.4011 | 2.082 | Good | Good |
| Ex. 16 | Cr₂N | TiN | 0.018 | 0.072 | 0.3826 | 2.965 | Good | Good |
| Ex. 17 | VN | Ultrahard shot | 0.015 | 0.029 | 0.4333 | 2.249 | Good | Good |
| Comp. Ex. 1 | VC | — | 0.015 | Tr | 0.2848 | 2.278 | Poor | Good |
| Comp. Ex. 2 | VC | — | 0.400 | 0.011 | 0.5978 | 4.184 | Poor | Poor |
| Comp. Ex. 3 | TaN | — | 0.400 | 0.024 | 0.6211 | 4.117 | Fair | Poor |
| Comp. Ex. 4 | TaN | — | 0.400 | 0.022 | 0.7012 | 5.784 | Fair | Poor |

The “amount of conductive compound particles anchored per unit area (mg/cm²)” described in Table 1 was measured using “energy dispersive X-ray spectroscopy” (EDX).

Further, the “evaluation of contact resistance” described in Table 1 was determined by measuring the contact resistance of the separator-use base member 1 and carbon paper and, based on that measured value, ranking the resistance as “good”, “fair”, and “poor” with “good” meaning 15 mΩ·cm² or less, “fair” meaning over 15 mΩ·cm² to less than 20 mΩ·cm², and “poor” meaning 20 mΩ·cm² or more.

Further, the “evaluation of warping on the diagonal line” described in Table 1 was determined by ranking warping, based on the measured value of warping of the separator-use base member 1 on the diagonal line (that is, difference of heights at two ends on diagonal line/distance of diagonal line=calculated value), as “good”, “fair”, and “poor” with “good” meaning 0.01 or less, “fair” meaning over 0.01 to less than 0.015, and “poor” meaning 0.015 or more.

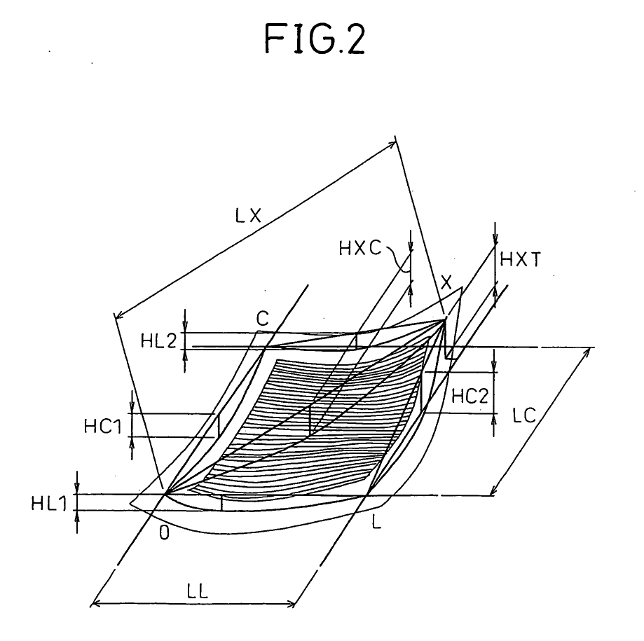

Note that, including the warping rates in the diagonal direction, the warping rates W_{L1}, W_{L2}, W_{C1}, W_{C2}, and W_{XC} were defined as follows: That is, as shown in FIG. 2, among the vicinities of four corners of the separator-use base member, one corner was used as the origin O. Designating the vicinity of the corner in the rolling direction of the separator-use base member from the origin O as “L”, the vicinity of the corner in the direction perpendicular to rolling of the separator-use base member from the origin O as “C”, the vicinity of the corner in the diagonal direction from the origin O as “X”, the length of the line segment between OL as “LL”, the length of the line segment OC as “LC”, the length between OX as “LX”, the maximum distortion height from the line OL to the center of the processed part in the thickness direction as “HL1”, the height from the line CX as “HL2”, the height from the line OC as “HC1”, the height from the line LX as “HC2”, the height from the line OX as “HXC”, and the distance from the point X to the plane comprised of the other points O, L, and C as “HXT”, the rates are defined by [formula 1] to [formula 5].

Among the vicinities of four corners of the separator-use base member, one corner was used as the origin O. Designating the vicinity of the corner in the rolling direction of the separator-use base member from the origin O as “L”, the vicinity of the corner in the direction perpendicular to rolling of the separator-use base member from the origin O as “C”, the vicinity of the corner in the diagonal direction from the origin O as “X”, the length of the line segment between OL as “LL”, the length of the line segment OC as “LC”, the length between OX as “LX”, the maximum distortion height from the line OL to the center of the processed part in the thickness direction as “H_{L1}”, the height from the line CX as “H_{L2}”, the height from the line OC as “H_{C1}”, the height from the line LX as “H_{C2}”, the height from the line OX as “H_{XC}”, and the distance from the point X to the plane comprised of the other three points O, L, and C as “H_{XT}”, the rates are defined by [formula 1] to [formula 5].

$$\begin{matrix}Back side L direction warping {W}_{L 1} = \frac{\vert {HL}_{1} \vert}{LL} & [ Formula 1 ] \\ Front side L direction warping {W}_{L 2} = \frac{\vert {HL}_{2} \vert}{LL} & [ Formula 2 ] \\ Left side C direction warping {W}_{C 1} = \frac{\vert {HC}_{1} \vert}{LC} & [ Formula 3 ] \\ Right side C direction warping {W}_{C 1} = \frac{\vert {HC}_{2} \vert}{LC} & [ Formula 4 ] \\ Diagonal direction warping {W}_{XC} = \frac{\vert HXC \vert}{LX} & [ Formula 5 ]\end{matrix}$$

### Example 18

Further, for the “evaluation of contact resistance” between the separator-use base member 1 and carbon paper, in step A for forming the conductive compound particle-coated layer, the amount of spray coating of the suspension per unit area on the surface of the separator-use base member 1 was changed in stages to 0.08 mg/cm², 0.2 mg/cm², and 0.4 mg/cm² to form conductive compound particle-coated layers, then step B of anchoring the conductive compound particles and step C of cleaning off the coated layer were performed in the same way as in Example 1 to drive in and anchor conductive compound particles 3 at the surface of each separator-use base member 1.

The mass of the conductive compound particles 3 driven in and anchored in the inside direction of each separator-use base member 1 was measured by “energy dispersive X-ray spectroscopy” (EDX). The mass was divided by the total mass of the conductive compound particles 3 in the spray coated layer, to obtain a ratio (%) shown by the “anchoring ratio”. Further, the contact resistance between the separator-use base member 1 and carbon paper when this anchoring ratio is obtained was measured and ranked. The result is shown as the “evaluation of contact resistance” in the following Table 2.

TABLE 2

| | | Evaluation of contact |
|---|---|---|
| Coated amount (mg/cm²) | Anchoring ratio (%) | resistance |
| 0.08 | 15 | Poor |
| 0.2 | 30 | Good |
| 0.4 | 60 | Good |

The “evaluation of contact resistance” described in Table 2 was determined, in the same way as Table 1, by measuring the contact resistance of the separator-use base member 1 and carbon paper and, based on that measured value, ranking the resistance as “good”, “fair”, and “poor” with “good” meaning 15 mΩ·cm² or less, “fair” meaning over 15 mΩ·cm² to less than 20 mΩ·cm², and “poor” meaning 20 mΩ·cm² or more.

Regarding the amount of anchored conductive compound particles 3 in the method of the prior art of directly blasting conductive compound particles 3 on the surface of the separator-use base member 1 to anchor the conductive compound particles 3 there, by making the blasting pressure of the conductive compound particle 3, as shown in Comparative Examples 2 to 4, 20 times or more of the blasting pressure of the blast particles 4 in the present invention, it is possible to obtain the minimum anchored amount of conductive compound particle 3 in the present invention (0.02 mg/cm²), but the amount of warping of the separator-use base member 1 on the diagonal line becomes greater, so there is the problem that anchoring by more than the minimum anchoring amount (0.02 mg/cm²) is not possible.

The present invention, as clear from Examples 1 to 17, uses, as the method for anchoring conductive compound particles 3 at the surface of the separator-use base member 1, the method of spray coating the surface of the separator-use base member 1 with a suspension of powder of the conductive compound particles 3 so as to form a conductive compound particle-coated layer 2, then blasting the conductive compound particle-coated layer 2 with blast particles 4 of any of ultrahard shot, TiN, or glass beads using blast air. Regardless of the type of the conductive compound particles 3 or type of the blast particles 4, it can therefore drive into the surface of the separator-use base member 1, with less energy and lower cost, conductive compound particles 3 to reliably anchor them there and therefore solve the problems of the prior art.

Further, as clear from Example 18, if making the ratio of mass (anchoring ratio), with respect to the total mass of the conductive compound particles in the coated layer spray coated for forming the conductive compound particle-coated layer, of the conductive compound particles in the conductive compound particle-coated layer driven in and anchored in the inside direction of the separator-use base member by blasting the conductive compound particle-coated layer with blast particles a ratio of 30% or more, the contact resistance of the separator-use base member and the carbon paper becomes 15 mΩ·cm² or less and a separator-use base member able to exhibit a good conductive performance can be produced.

1. A method of treatment for imparting conductivity to a separator-use base member of a solid polymer type fuel cell which treats the surface of a separator-use base member of a solid polymer type fuel cell made of any of a sheet of stainless steel, titanium, or titanium alloy by a step of spray coating and drying a suspension prepared by mixing conductive compound particles of an average particle size of 1 to 10 μm with ethanol or water so as to form a conductive compound particle-coated layer, a step of blasting the conductive compound particle-coated layer with blast particles having an average particle size of 50 to 200 μm so as to drive said conductive compound particles coated on the surface of the base member in the inside direction of the separator-use base member to anchor them there, and a step of cleaning off conductive compound particles not anchored to the separator-use base member at that step and impurities on the surface of the separator base member.

2. A method of treatment for imparting conductivity to a separator-use base member of a solid polymer type fuel cell according to claim 1, wherein a speed of blast particles used as the means for blasting the conductive compound particle-coated layer is 10 to 30 m/sec.

3. A method of treatment for imparting conductivity to a separator-use base member of a solid polymer type fuel cell according to claim 1, wherein a blast air pressure used as means for blasting the blast particles at the conductive compound particle-coated layer is 0.01 to 0.1 MPa.

4. A method of treatment for imparting conductivity to a separator-use base member of a solid polymer type fuel cell according to any one of claims 1 to 3, wherein said conductive compound particles are powders comprised of at least one type of compound selected from Cr₂B, CrB₂, VB, TaB₂, WB, Cr₃C₂, WC, VC, TaC, Mo₂C, Cr₂N, VN, and TaN.

5. A method of treatment for imparting conductivity to a separator-use base member of a solid polymer type fuel cell according to claim 1, wherein ratio of mass, with respect to a total mass of conductive compound particles of said conductive compound particle-coated layer, of the conductive compound particles anchored by being driven in the inside direction of said separator-use base member after blasting the conductive compound particle-coated layer with the blast particles is 30% or more.
